(19) United States
(12) Patent Application Publication
(10) Pub. No.: US 2010/0123093 A1
(43) Pub. Date: May 20, 2010

(54) ELECTROMAGNETIC DRIVE WITH A LIFTING ARMATURE

(76) Inventors: Olaf Beyer, Dresden (DE); Martin Doerr, Ingelfingen (DE); Willheim Gauss, Niedemhall (DE); Martin Hettinger, Ingelfingen (DE); Sebastian Kahl, Forchtenberg (DE)

Correspondence Address: CARLSON, GASKEY & OLDS, P.C., 400 WEST MAPLE ROAD, SUITE 350, BIRMINGHAM, MI, 48009, US

(21) Appl. No.: 12/620,615

(22) Filed: Nov. 18, 2009

(30) Foreign Application Priority Data
Nov. 19, 2008 (DE) 20 2008 015 303.4

(51) Int. Cl. F16K 31/02

(52) U.S. Cl. 251/129.15

(57) ABSTRACT

An electromagnetic drive with a lifting armature is disclosed, in particular for a valve, which, while having small dimensions, is suitable to achieve high magnetic forces and the components of which can be freely combined with one another in a large variety of ways. This allows an adaptation to a specified structural space without specific components having to be fabricated. The same standardized components are just combined with each other differently. The drive includes a magnetic yoke with two parallel spaced yoke legs, a yoke rod extending perpendicular to and connecting the yoke legs, a yoke stud extending parallel to the yoke rod and spaced from the yoke rod, and a core plug extending coaxially with the yoke stud. The core plug is axially movable and passes through one of the yoke legs. The core plug further defines an air gap with the yoke stud.

### RELATED APPLICATION

This application claims priority to German application 20 2008 015 303.4, which was filed Nov. 19, 2008.

### FIELD OF THE INVENTION

The present invention relates to an electromagnetic drive with a lifting armature, in particular for a valve.

### BACKGROUND OF THE INVENTION

Lifting armature drives are widely used in valves and relays. They are particularly suitable for miniaturized designs. The essential components of a lifting armature drive include a magnetic yoke that constitutes a ferromagnetic circuit and a solenoid coil that surrounds one of the yoke legs. The other yoke leg is divided into a fixed component of the magnetic yoke and a movable rod which constitutes the actuating member of the drive.

### SUMMARY OF THE INVENTION

The invention provides an electromagnetic drive with a lifting armature, in particular for a valve, which, while having small dimensions, is suitable to achieve high magnetic forces and the components of which can be freely combined with one another in a large variety of ways. This allows an adaptation to a specified structural space without specific components having to be fabricated. The same standardized components are just combined with each other differently.

Several embodiments of the invention are specified in the appended claims.

In a first embodiment, the yoke rod is surrounded by a first solenoid coil and the yoke stud with part of the core plug is surrounded by a second solenoid coil. The dual configuration of the solenoid coil results in an increase in the magnetic forces without an increase in the overall height and overall width. Only the overall depth increases which, as a rule, is not critical. It is already disclosed per se in DE 201 00 471 U1 to provide a hinged armature drive with a solenoid coil on both yoke legs. But the yoke design proposed there does not allow a flexible use of the components in different combinations.

According to another embodiment of the invention, the yoke rod has a diameter which is reduced relative to the diameters of the yoke stud and the core plug, and the solenoid coil surrounding the yoke rod has a correspondingly increased winding volume. This measure also increases the attainable magnetic forces. The reduced diameter of the yoke rod may be compensated for by using high-quality soft iron.

Various designs of solenoid coils, yoke rods, yoke legs, yoke studs and core plugs may be freely combined in an advantageous manner.

Another subject matter of the invention is a valve, in particular a miniaturized solenoid valve, including a lifting armature drive of the type described above. The core plug has an outer axial face end carrying a sealing body that cooperates with a sealing seat of the valve.

A further subject matter of the invention is a valve, in particular a miniaturized solenoid valve, including a lifting armature drive of the type described above. The core plug has an outer axial face end actuating a switching rocker which in turn actuates a diaphragm cooperating with two sealing seats of the valve.

The special advantages of the lifting armature drive according to the invention are in particular as follows:

There is a force-lift characteristic as in a conventional lifting armature. Since only a variable air gap exists, in comparison with a plate armature a higher force level results for larger air gaps.

The winding window of both solenoid coils together is twice as large as that of a single coil. In terms of effect, a coil of twice the overall height is provided, but hardly any iron is required for the flux feedback. With the electrical power being the same, the force-lift characteristic of a single-coil system at 110% of the rated current corresponds to that of the dual-coil system at 70% of the rated current.

The overall height and/or the overall width of the drive or valve may be reduced if it is desired to produce magnetic forces equal to those in the single-coil system. Only the overall depth, which is not critical in most cases, increases somewhat.

When two solenoid coils are used, an overexcitation may be produced in a simple manner by changing over between a parallel connection and a series connection.

A secure adaption of the coils may be effected by means of connector lugs with the aid of a printed circuit board which may also mount drive electronics.

In the area of the lifting armature, it is possible to apply all of the specifications as with simple lifting armature systems, namely, a thrust cone for proportional solenoids and switching magnets, a short-circuit ring for alternating current versions, permanent magnets for pulse variants, a pole sleeve, or a pole piece for improving the flux conduction.

When provision is made for a media separation in the valve, the highest magnetic force is achieved if the core plug, the yoke stud, and the yoke rod are produced from a magnetizable material having as high a saturation magnetization as possible, such as cobalt iron, for example.

In connection with cobalt iron used for the core, the stud and the yoke rod as well as an E-band for the two yoke sheet metal stacks, in the case of media separation the materials of the ferromagnetic circuit are thus optimized.

Such materials are, however, susceptible to corrosion and may therefore not be employed in drives without a media separation.

For drives without a media separation the ferromagnetic circuit may be made up of various combinations of materials.

For optimizing the magnetic force, the parts which are in contact with the medium, i.e. the yoke stud and the core plug, that are used here are made of nobler steels not susceptible to corrosion, which are less favorable magnetically, but, to make up for that, they are produced with larger diameters. This iron cross-section is thus increased on the part of the valve actuating element. The stationary yoke rod, which is not in contact with the medium, is produced from a material having good magnetizability. Its cross-section may be selected to be smaller, as a result of which more coil space is available.

The ferromagnetic circuit is optimized by combining different components such as solenoid coils, yoke rods, yoke legs, yoke studs and core plugs of various designs.

These and other features of the present invention can be best understood from the following specification and drawings, the following of which is a brief description.

### BRIEF DESCRIPTION OF THE DRAWINGS

Further advantages and features of the invention will be apparent from the description below of several embodiments with reference to the accompanying drawings, in which:

FIG. 1 shows a schematic diagram of a lifting armature drive with a dual solenoid coil and coupling to a seat valve;

FIG. 2 shows schematic sectional views of different embodiments of the lifting armature drive;

FIG. 3 shows schematic sectional views of different embodiments of the lifting armature drive;

FIG. 4 shows schematic sectional views of different embodiments of the lifting armature drive;

FIG. 5 shows schematic sectional views of different embodiments of the lifting armature drive; and

FIG. 6 shows a schematic sectional view of a valve with a variant of the lifting armature drive.

### DETAILED DESCRIPTION OF THE PREFERRED EMBODIMENT

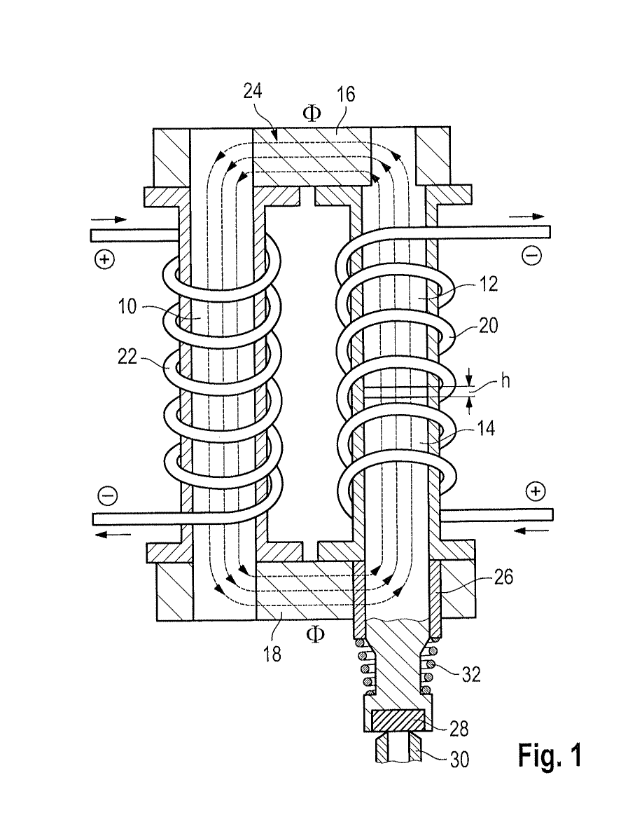

The lifting armature drive shown in FIG. 1 consists of a magnetic yoke and two solenoid coils. The magnetic yoke is made up of a yoke rod 10, a yoke stud 12, a core plug 14, and two yoke legs 16, 18. The magnetic yoke constitutes a ferromagnetic circuit which is only interrupted by an air gap of a height h between the yoke stud 12 and the core plug 14. A first solenoid coil 20 surrounds the yoke stud 12 and the core plug 14. A second solenoid coil 22 surrounds the yoke rod 10. The solenoid coils 20, 22 may be operated in parallel or in a series connection. With the polarities as specified in FIG. 1, a flux direction of the magnetic flux Φ is obtained as indicated by arrows 24.

The core plug 14 is guided for axial movement and passes through a pole sleeve 26 inserted in an opening of the yoke leg 18. The free face end of the core plug 14 carries a sealing body 28 which cooperates with a sealing seat 30 of a valve that is indicated only by this sealing seat 30 in FIG. 1. A compression spring 32 is supported between a shoulder on the face end of the core plug 14 and the pole sleeve 26 and urges the core plug 14 against the sealing seat 30.

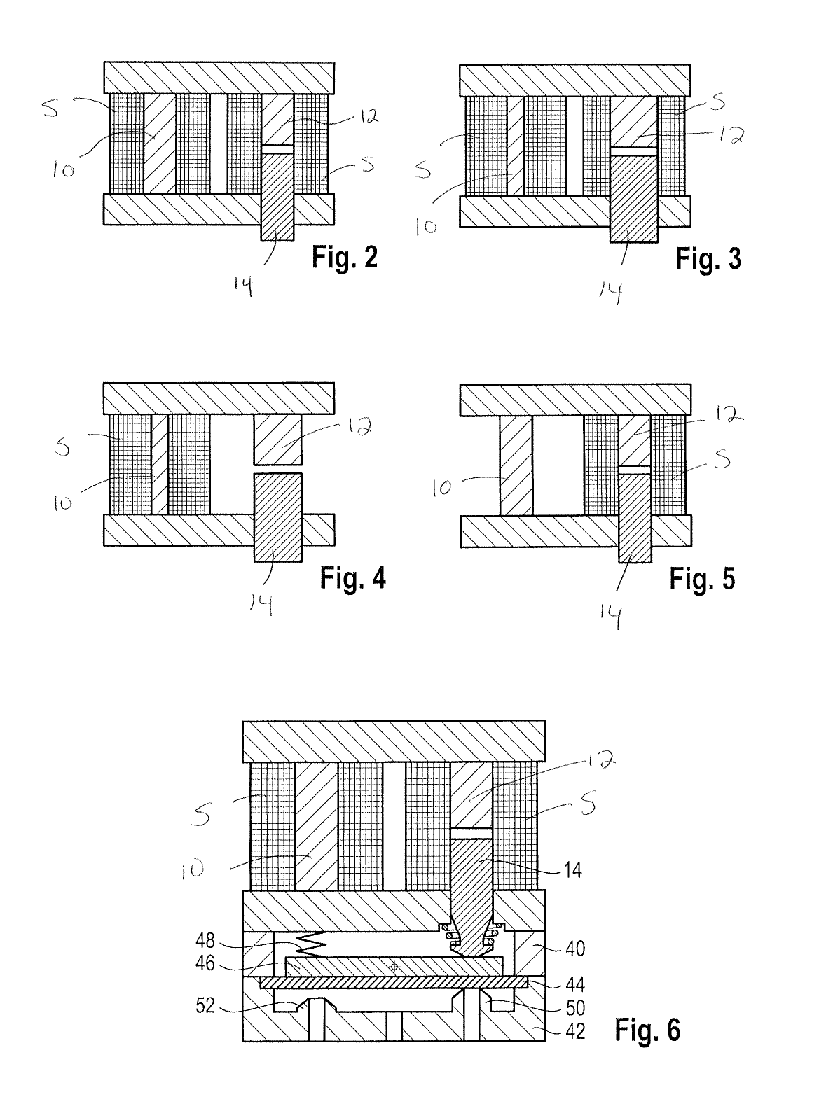

The various components of the lifting armature drive may be configured in different sizes and structural shapes and combined with each other in different ways, as will now be discussed with reference to FIGS. 2 to 5.

FIG. 2 shows a configuration having two identical solenoid coils S and with the yoke rod 10 and the core plug 14 having diameters of equal dimensions. In comparison with solenoid valves containing only one coil, the magnetic force is considerably increased, with the overall height and width being the same.

FIG. 3 illustrates an exemplary embodiment which is particularly favorable when no media separation is provided for in the valve. For this reason, the yoke stud 12 and the core plug 14 are produced from a corrosion-resistant steel, which is less favorable magnetically.

Under these circumstances an optimum magnetic force may be achieved if the cross-section of the yoke stud 12 and the core plug 14 is increased. Compared with the yoke stud 12 and the core plug 14, the yoke rod 10 is made to have a reduced diameter and the winding spaces of the respective solenoid coils S are dimensioned correspondingly larger or smaller.

The reduced diameter of the yoke rod 10 may be compensated for by making it from a high-quality soft iron.

The modification in FIG. 4 as compared to FIG. 3 resides in that only one solenoid coil S is used, which surrounds the yoke rod 10.

In the variant of FIG. 5, the solenoid coil S surround only the yoke stud 12 and the core plug 14. While this exemplary embodiment essentially corresponds to known solenoid valves, this arrangement acts to reduce undesirably occurring leakage flux. This means that in alternative systems such as a pot magnet or a coil that is surrounded by stirrup yokes, substantially larger magnetically conducting surfaces are located opposite each other within the yoke legs than in the exemplary embodiment having yoke rods described here. The yoke rod is arranged parallel to, but spaced from, the coil.

FIG. 6 shows an application of the lifting armature drive in the configuration according to FIG. 2 as a drive of a valve. The valve includes two housing parts 40, 42 that are separated by a diaphragm 44 that is clamped between the two housing ports 40, 42. A rocker 46 is mounted for pivoting motion in the housing part 40. The core plug 14 of the lifting armature drive presses against one end of the rocker 46, and the other end of the rocker 46 is acted upon by a compression spring 48. The housing part 42 has two sealing seats 50, 52 formed therein. By pivoting the rocker 46, the diaphragm 44 is moved against one or the other sealing seat 50, 52.

Although the invention has been described hereinabove with reference to a specific embodiment, it is not limited to this embodiment and no doubt further alternatives will occur to the skilled person that lie within the scope of the invention as claimed.

What is claimed is:

1. An electromagnetic drive with a lifting armature drive, in particular for a valve, comprising:
a magnetic yoke including
two parallel spaced yoke legs;
a yoke rod extending perpendicular to and connecting the yoke legs;
a yoke stud extending parallel to the yoke rod and spaced from the yoke rod; and
a core plug extending coaxially with the yoke stud, wherein the core plug is axially movable and passes through one of the yoke legs, the core plug further defining an air gap with the yoke stud, and wherein the yoke rod is surrounded by a first solenoid coil and the yoke stud with part of the core plug is surrounded by a second solenoid coil.

2. The lifting armature drive according to claim 1, wherein the yoke rod has a reduced diameter relative to diameters of the yoke stud and the core plug, and the first solenoid coil surrounding the yoke rod has a correspondingly increased winding volume.

3. The lifting armature drive according to claim 2, wherein the yoke rod having the reduced diameter is comprised of a high-quality soft iron.

4. An electromagnetic drive with a lifting armature drive, in particular for a valve, comprising:
a magnetic yoke including
two parallel spaced yoke legs;
a yoke rod extending perpendicular to and connecting the yoke legs;
a yoke stud extending parallel to the yoke rod and spaced from the yoke rod; and
a core plug extending coaxially with the yoke stud, wherein the core plug is axially movable and passes through one of the yoke legs, the core plug further defining an air gap with the yoke stud, and wherein only the yoke rod is surrounded by a solenoid coil and the yoke rod has a reduced diameter relative to diameters of the yoke stud and the core plug, and the solenoid coil surrounding the yoke rod has a correspondingly increased winding volume.

5. The lifting armature drive according to claim 4, wherein the yoke legs are formed of laminated metal sheets.

6. The lifting armature drive according to claim 4, wherein solenoid coil connections are pin-shaped and are to be guided axially to a printed circuit board adjacent to a yoke leg.

7. The lifting armature drive according to claim 4, wherein the yoke legs are selected from a group of yoke legs comprising a plurality of different yoke leg configurations;
wherein the solenoid coil is selected from a group of solenoid coils comprising a plurality of different solenoid coil configurations;
wherein the yoke rod is selected from a group of yoke rods comprising a plurality of different yoke rods;
wherein the yoke stud is selected from a group of yoke studs comprising a plurality of different yoke studs;
wherein the core plug is selected from a group of core plugs comprising a plurality of different core plugs; and
wherein yoke legs, solenoid coils, yoke rods, yoke studs, and core plugs are selected in any of various desired combinations to provide the lifting armature drive.

8. A valve, in particular a miniaturized solenoid valve, comprising:
a lifting armature drive comprising a magnetic yoke including
two parallel spaced yoke legs;
a yoke rod extending perpendicular to and connecting the yoke legs,
a yoke stud extending parallel to the yoke rod and spaced from the yoke rod,
a core plug extending coaxially with the yoke stud, wherein the core plug is axially movable and passes through one of the yoke legs, the core plug further defining an air gap with the yoke stud, and
wherein the yoke rod is surrounded by a first solenoid coil, and the yoke stud with part of the core plug is surrounded by a second solenoid coil, or
wherein only the yoke rod is surrounded by a solenoid coil and the yoke rod has a reduced diameter relative to diameters of the yoke stud and the core plug, and the solenoid coil surrounding the yoke rod has a correspondingly increased winding volume; and
wherein the core plug has an outer axial face end carrying a sealing body that cooperates with a sealing seat of the valve.

9. A valve, in particular a miniaturized solenoid valve, comprising:
an electromagnetic drive with a lifting armature comprising a magnetic yoke including
two parallel spaced yoke legs;
a yoke rod extending perpendicular to and connecting the yoke legs,
a yoke stud extending parallel to the yoke rod and spaced from the yoke rod,
a core plug extending coaxially with the yoke stud, wherein the core plug is axially movable and passes through one of the yoke legs, the core plug further defining an air gap with the yoke stud, and
wherein the yoke rod is surrounded by a first solenoid coil, and the yoke stud with part of the core plug is surrounded by a second solenoid coil, or
wherein only the yoke rod is surrounded by a solenoid coil and the yoke rod has a reduced diameter relative to diameters of the yoke stud and the core plug, and the solenoid coil surrounding the yoke rod has a correspondingly increased winding volume; and
wherein the core plug has an outer axial face end actuating a switching rocker which in turn actuates a diaphragm cooperating with two sealing seats of the valve.

10. The valve according to claim 9, with a media separation between the electromagnetic drive and a fluid side, wherein components of the magnetic yoke are comprised of a high saturation magnetization material.

11. The valve according to claim 9, without a media separation between the electromagnetic drive and a fluid side, wherein components of the magnetic yoke which are in fluid contact are comprised of a corrosion-resistant material and are dimensioned to be larger as compared with a configuration made from a high saturation magnetization material.

12. The valve according to claim 8, with a media separation between the electromagnetic drive and a fluid side, wherein components of the magnetic yoke are comprised of a high saturation magnetization material.

13. The valve according to claim 8, without a media separation between the electromagnetic drive and a fluid side, wherein components of the magnetic yoke which are in fluid contact are comprised of a corrosion-resistant material and are dimensioned to be larger as compared with a configuration made from a high saturation magnetization material.

14. The lifting armature drive according to claim 1, wherein the yoke legs are formed of laminated metal sheets.

15. The lifting armature drive according to claim 1, wherein solenoid coil connections are pin-shaped and are to be guided axially to a printed circuit board adjacent to a yoke leg.

16. The lifting armature drive according to claim 1, wherein the yoke legs are selected from a group of yoke legs comprising a plurality of different yoke leg configurations;
wherein the solenoid coil is selected from a group of solenoid coils comprising a plurality of different solenoid coil configurations;
wherein the yoke rod is selected from a group of yoke rods comprising a plurality of different yoke rods;
wherein the yoke stud is selected from a group of yoke studs comprising a plurality of different yoke studs;
wherein the core plug is selected from a group of core plugs comprising a plurality of different core plugs; and
wherein yoke legs, solenoid coils, yoke rods, yoke studs, and core plugs can be selected in any of various desired combinations to provide the lifting armature drive.
